(19) United States
(12) Patent Application Publication
(10) Pub. No.: US 2008/0159139 A1
(43) Pub. Date: Jul. 3, 2008

(54) METHOD AND SYSTEM FOR A CONTEXT MANAGER FOR A CONVERGED SERVICES FRAMEWORK

(75) Inventors: Patrick D. SMITH, Deerfield, IL (US); Patrick M. Maurer, Wayland, MA (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/617,754

(22) Filed: Dec. 29, 2006

(51) Int. Cl. G08C 15/00

(52) U.S. Cl. 370/231

(57) ABSTRACT

A method, apparatus, and electronic device that facilitate the use of a converged service in a hierarchical network are disclosed. The method may include providing a converged service instance across a plurality of independent networks to an end user; selecting a hierarchical control sub-element using a context manager; and controlling with the hierarchical control sub-element an aspect of the converged service instance.

### BACKGROUND OF THE INVENTION

1. Field of the Invention

The present invention relates to a method and system for managing a converged service across multiple domains. The present invention further relates to domains that are arranged in a hierarchical rather than peer-to-peer structure.

2. Introduction

Networks of various kinds are known in the art. These include, as illustrative examples, access networks, control networks, and services networks (with those skilled in the art recognizing that any given network may serve as one or more of these network types, such that a given network may comprise, for example, both an access and control network). A service from one network may be integrated with a service from a second network to a partial or total extent. More typically, however, such networks operate independently of one another to a greater or lesser extent. (As used herein, “independent” can refer to technological independence (as when two networks are unable to access one another due to lack of, for example, a facilitating connection), and/or operational independence (as when two networks are separately administered in a manner that wholly or partially precludes transparent interaction).)

As a result, a typical modern user has access to a vast number of differing services and/or end-user interface devices that, in many cases, operate utterly independently of one another. Applications allow a given end-user (or other network element or node) access to various services and actions. To put it another way, networks provide the conduit by which an application-based service reaches a given end-user.

At present, more often than not, a given application requires considerable native intelligence and vertical awareness in order to work successfully in or with a given network. This “vertical awareness” may be an awareness of the bandwidth, delay or jitter between source, and sink of content. “Vertical awareness” may also include awareness of specific formats of control for setting up and ‘tearing down’ a connection. Vertical awareness may include awareness of a network-specific identifier for a user, application or device. Vertical awareness may mean awareness of the entire open systems interconnection (OSI) “stack”. This situation reflects the simple fact that most networks, one way or the other, are independent from one another, thus largely frustrating any intent to extend the reach of a given application across multiple networks.

One group of applications that may operate in this type of environment is converged services. Converged services may encompass coordinated services, continuous services, and integrated services. The user experience is the constant in determining whether this is a converged service. A service exhibits “continuity” if it is perceived by the user to perform the same task in the same way as it crosses access networks, devices, or administrative domains (service ownership), although that service may be implemented differently across network boundaries, such as a cellular voice call when compared with a WLAN VoIP voice call. Two or more services would be “coordinated” if, in their original form, they were independent, but are caused to interact with one another; that is, one service changes its behavior in response to a state change in the other. For example, a video stream on TV that pauses when a phone rings. Services are “integrated” when they are combined to the point that they appear to the user as a single service.

One proposed solution to address such concerns comprises a service convergence fabric interposed between a plurality of independent access networks, control networks, and service networks on the one hand and a converged application layer on the other. (See, for example, a previously filed provisional patent application entitled METHOD TO FACILITATE A SERVICE CONVERGENCE FABRIC as was filed on Nov. 22, 2004 and having application No. 60/630,106, the full contents of which are incorporated herein by this reference.)

The converged service fabric (CSF) allows for the decoupling of the services, or applications, from the access networks. This separation introduced by the CSF architectural element 110 created two logically distinct spaces, the applications space 120 and the access space 130, as shown in FIG. 1. Properly configured and deployed, such a service convergence fabric effectively serves as an application server with respect to the plurality of access networks and control networks and as a control server or application gateway with respect to the plurality of services networks. Viewed in a different aspect, to preserve a capability of operation with legacy networks, the service convergence fabric preferably interacts with services networks in a manner consistent with that of the behavior of access or control networks, while also interacting with access or control networks in a manner consistent with that of the behavior of services networks. Such a service convergence fabric typically has access to information regarding at least one of end-user information, service information, network information, device information, resource information, application information, and/or edge gateway information.

Previous incarnations of the CSF do not disclose a control architecture that may be deployed in a distributed or hierarchical way, but rather relies on a peer-to-peer model. Because the CSF acts in a peer manner, a user's converged service request must be granted then established through the control architecture, resulting in the set up time being limited by the control architecture response time. Due to the nature of the CSF system collecting and interpreting information across multiple application and access networks, converged services will further be limited by the response time of each individual control element across the networks. The complete awareness of the user's resource states across multiple application and access networks is provided at the expense of creating intra-network dependencies. This limitation may prevent the converged service system from responding in a timely fashion. Latency-sensitive services may be dropped or produce unacceptable performance such as glitches in video or gaps in audio communications. The current art also does not address converged service performance when one of the access or service networks is working in the presence of congestive traffic. Such traffic may prevent the CSF control element from processing the converged service request in a timely manner. A converged service offered by a service provider may fail if quality cannot be reasonably guaranteed.

### SUMMARY OF THE INVENTION

A method, apparatus, and electronic device that facilitate the use of a converged service in a hierarchical network are disclosed. The method may include providing a converged service instance across a plurality of independent networks to an end user; selecting a hierarchical control sub-element using a context manager; and controlling with the hierarchical control sub-element an aspect of the converged service instance.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a converged service fabric in accordance with a possible embodiment of the invention;

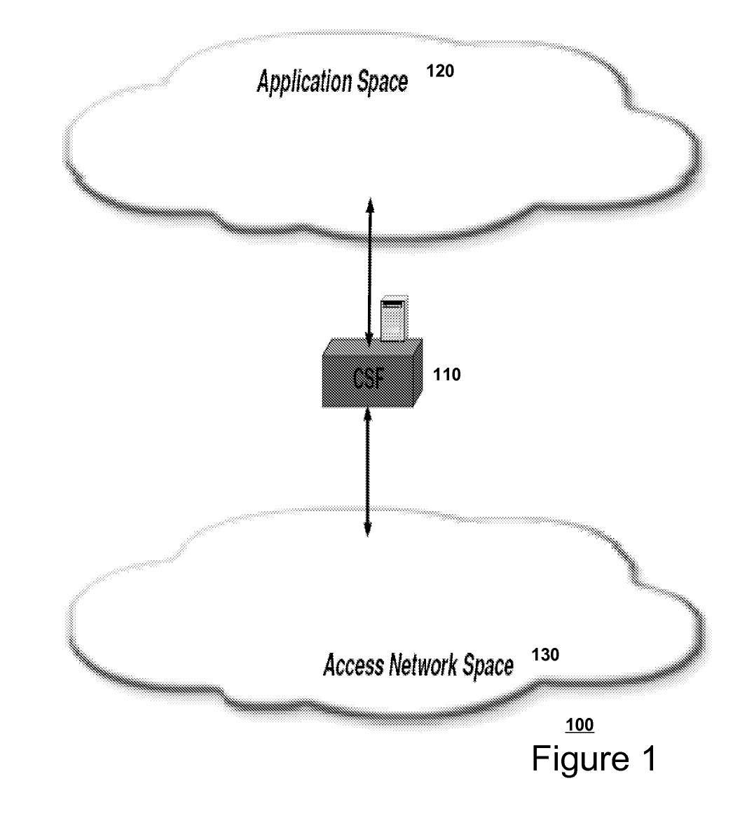

FIG. 2 illustrates the operation of the control architecture of the converged service fabric that operates in a peer relationship.

FIG. 3 illustrates one possible embodiment of the operation of the control architecture of the converged service fabric that operates in a hierarchical relationship.

FIG. 4 illustrates one embodiment of a context manager.

FIG. 5 illustrates one embodiment of a peer converged service fabric architecture.

FIG. 6 illustrates a possible embodiment of the interaction of these control elements and support functions within a converged service fabric.

FIG. 7 illustrates a possible embodiment of a distributed control sub-element may reside in hierarchical converged services fabric.

FIG. 8 illustrates one embodiment of a method for publishing a context manager request.

FIG. 9 illustrates one embodiment of a method for processing a service policy the context manager.

FIG. 10 illustrates one embodiment of a method for updating the context manager.

FIG. 11 illustrates a possible configuration of a computer system to act as a user terminal or server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention.

A method, apparatus, and electronic device that facilitate the use of a converged service in a hierarchical network are disclosed. A converged service instance is provided across a plurality of independent networks to an end user. The converged service fabric (CSF) control architecture selects a hierarchical control sub-element using a context manager. The selected hierarchical control sub-element controls an aspect of the converged service instance. The CSF control architecture provides the ability to delegate certain authority, cache certain preferences (such as known responses to typical, short fuse queries), fill in gaps, and query up the hierarchy in response to irresolvable ambiguity.

With any service, the application server may be different from, and remote from, the application user. In the CSF model, primary responsibility for information associated with that application is held by some CSF control element “closest” to the application. However, this control element may be far from the end user. This control element may, in effect, delegate this responsibility to a coordination function “further” from the application but closer to the end user. The purpose of such delegation is to improve responsiveness to state changes or requests.

Note that this approach might not be optimal when multiple services are coordinated; that is, a control element “closest” (in terms of response time) to the end user for one application might not be closest for another application. This is because, though a single control element that is physically closest to a user can be determined, this control element may have to draw information from, or issue commands to, elements in other networks. So, the best choice of control element requires joint optimization.

Establishing the best overall response time across applications involves balancing the response with respect to one application with that of the other applications in use. This approach can produce a better point of coordination, and as a result a better response, than a per-application approach. The idea disclosed here is a hierarchical structure for distributing state information, balancing trust, which favors withholding information, and responsiveness, which favors providing information. In addition, the closer a control element is to the “center”, the better its visibility. A natural example of this is a control element in the core of a service provider network, being able to see across entire network, versus a control element in a local area network (LAN), which can only see across the LAN and perhaps a small part of the entire network. Note, while a wide area network (WAN) has by nature a more global view, each control element may be at the top of a hierarchy from the perspective of a certain application or piece of information.

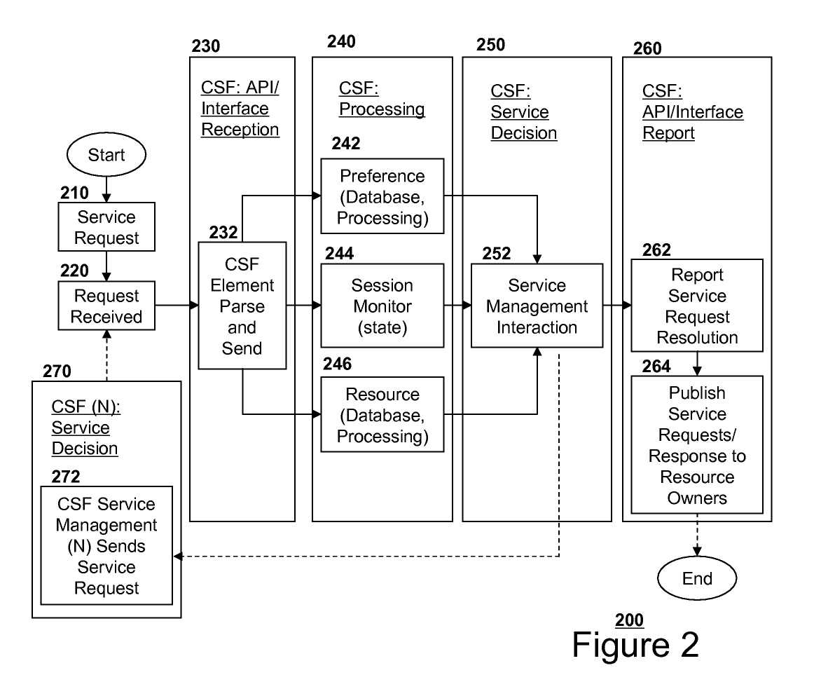

FIG. 2 illustrates the operation 200 of the control architecture of the CSF that operates in a peer relationship. The process starts when an application, user, or other entity sends a service request (Block 210). A CSF element may receive the request (Block 220). At the API/interface reception stage 230, the CSF element may parse the request and may send the request to the appropriate processing element (Block 232). At the processing stage 240, a user preference manager 242 provides the user preferences (such as database and processing), while a session monitor 244 determines the state and the resource manager 246 determines the necessary resources to perform the service. At the service decision stage 250, the control architecture manages the converged service (Block 252). If the CSF element may perform the services required, it proceeds to the API/interface report stage 260. The CSF element may report the service request resolution to the requesting entity (Block 262) and publish the service request or requests, or the response to the resource owners (access networks, clients, RGW etc.) and other recipients or requestors (Block 264). If the CSF element is unable or unwilling to perform the services required, it proceeds to the Service Transfer stage 270, where the CSF service management sends the service request to an alternate CSF element (Block 272).

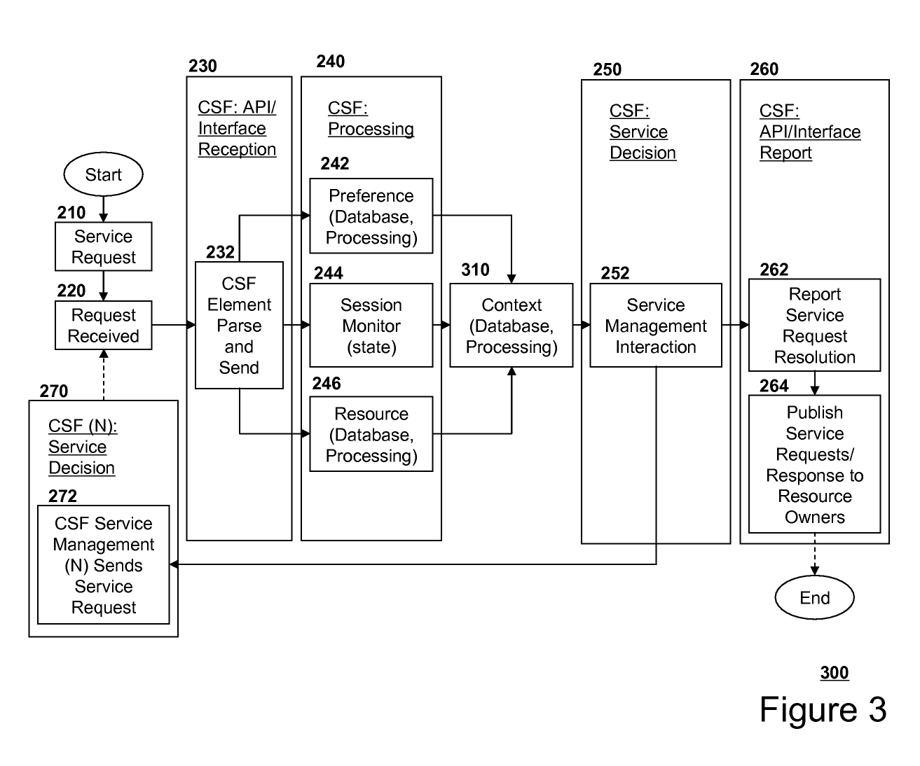

FIG. 3 illustrates one possible embodiment of the operation 300 of the control architecture of the CSF that operates in a hierarchical relationship. The hierarchical structure of this embodiment of the CSF improves upon the peer structure by including a context manager 310. A context manager 310 may receive the context information collected during the processing stage to determine which CSF control element is best suited to manage and perform the requested task. This structure allows for control sub-elements to be located in a proximity to the service applications or the end users so as to maximize the efficacy of service.

Given the hierarchical relationship above, a given CSF control element in the network can act to resolve a converged service request from an application or a user if the local resources are capable of producing the desired converged service behavior. However, an additional enabling element is required to allow this localized service coordination for the converged service request in this situation. The context manager may act as the enabler to provide this action.

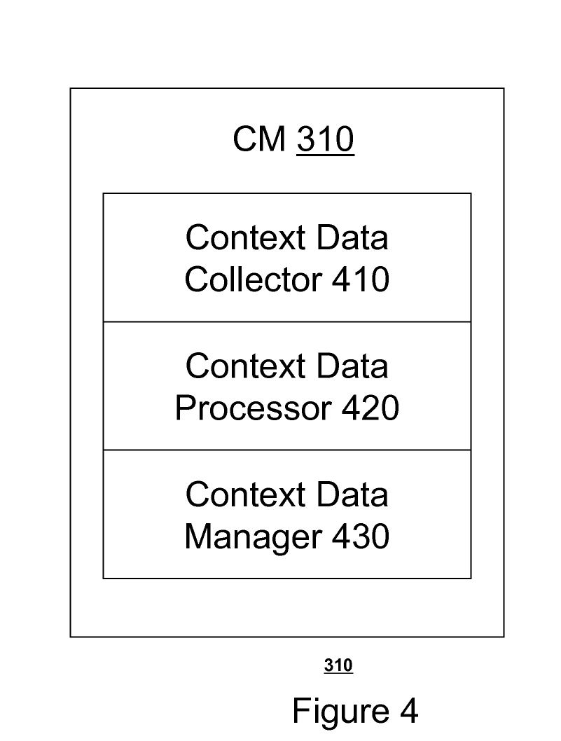

FIG. 4 illustrates one embodiment of a context manager (CM) 310. A CM 310 may include a context data collector 410, a context data processor 420, and a context data manager 430.

A context data collector 410 collects context state information, including a user's and his or her applications' location (such as physical, street/room, network, etc.), device proximity, user presence, availability and preferences. A primary use of the CM 310 would be to determine the necessary control element for enabling a converged service request, as applied to the current location of the user and the applications and networks needed to implement the service. The tiers of locality may include multiple services or applications within a single device, multiple services or applications operated within a peer area network, a service delivered to a device in conjunction with a device-local application, and multiple wide area network-based services delivered to a residential network.

The context data processor 420 may derive the current context of a user by processing the location and associating the location with known meanings, preferences, current user identities, availability, and presence information. CM 310 processing ensures the collected information provides uniform context interpretation for applications and users. The specific context processing conditions and actions may include across networks, across devices, across applications, prioritization of instances destined to a user based on the context the user is in, elimination of inconsistencies, maintaining consistency across data gathered from support layers in different devices, gateways and/or access networks, sending appropriate triggers to applications based on call back request, and pushing and pulling context information and context changes gathered about a user to the various applications and other network CM requesters.

The context data manager 430 may perform updates and synchronization of the database across the CSF's hierarchical structure to maintain a coherent state of the user and his resources.

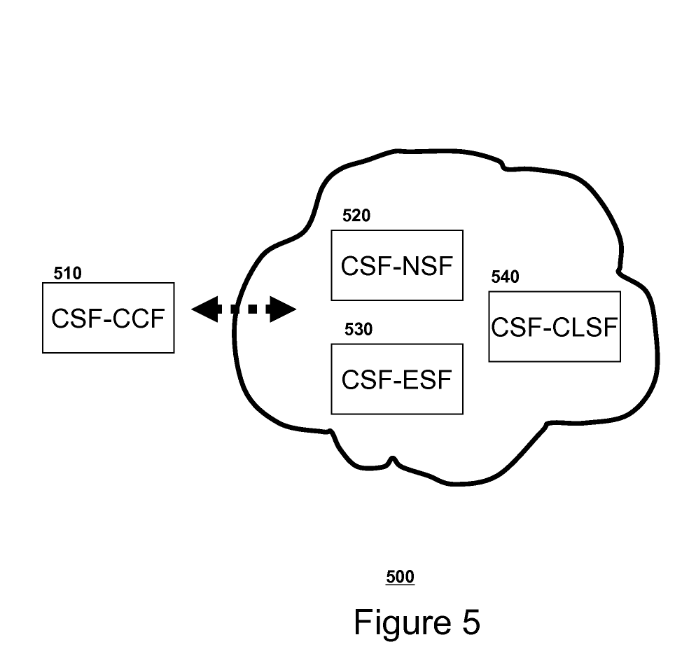

In both a peer and hierarchical structure, the CSF architecture may include a number of control elements and support functions, as shown in FIG. 5. The control element 510, also referred to as a convergence coordination function (CCF), may coordinate the multiple preferences, resources, and instances created by each access and service network to create and maintain a consistent convergence offering. The CCF 510 may interact with a set of support functions in furtherance of this aim. These support functions may include a network support function (NSF) 520, an edge node support function (ESF) 530, and a client support function (CLSF) 540. The NSF 520 provides an interface to each access network's instance controls. The ESF 530 provides an interface to each access network and edge node subtending devices. The CLSF 540 provides an interface to the end user clients.

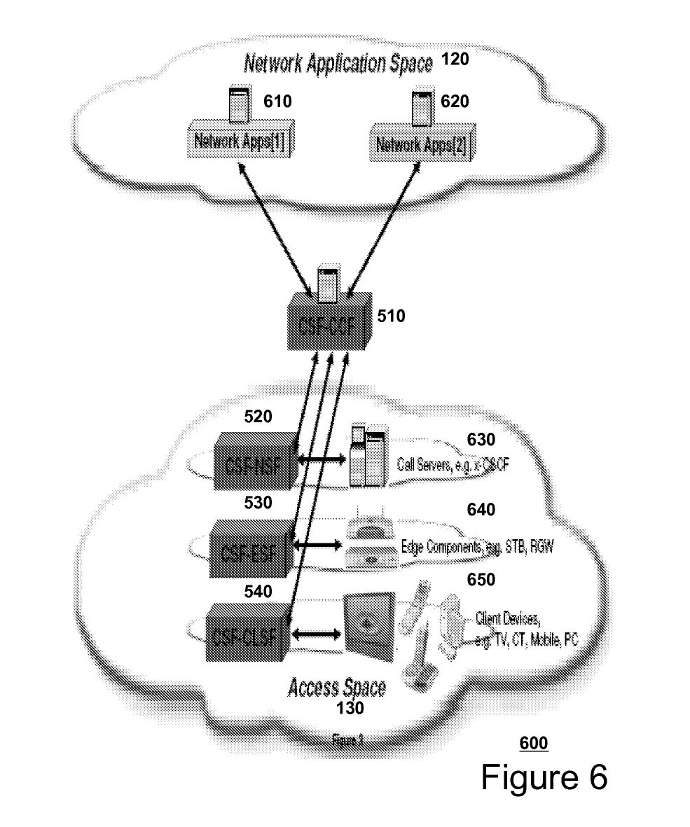

FIG. 6 illustrates a possible embodiment of the interaction of these control elements and support functions within a CSF 600. A first network application 610 and a second network application 620 interact with the CCF 510. While only two applications are mentioned in this example, more may be used. The CCF 510 may coordinate and control each of the support functions. The NSF 520 creates and maintains an interface with the call servers and other network devices 630. The ESF 530 creates and maintains an interface with the edge components 640. The CLSF 540 creates and maintains an interface with the client devices 650.

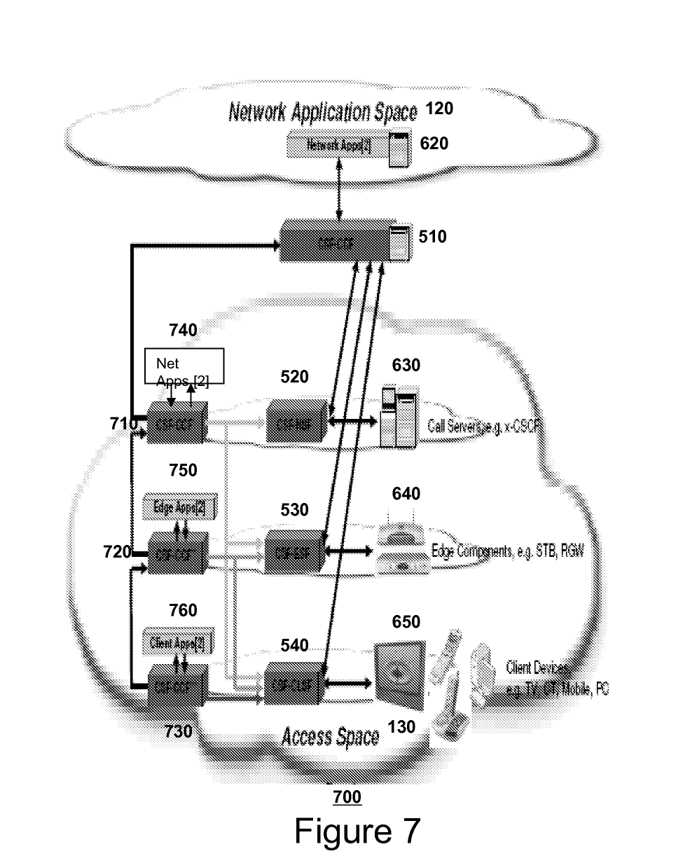

Applying the context manager allows for a distributed control model, such as a partly hierarchical distribution of CSF-CCF control elements across the networks, edge devices and client devices. As shown in FIG. 7, a distributed CSF-CCF sub-element may reside in individual networks 630 (CSF-CCF′ 710), edge devices 640 (CSF-CCF″ 720), and/or end clients 650 (CSF-CCF′″ 730). Each CCF sub-element may have a narrower scope than the supra-element 510 above it. Scope here refers to a sense of the locality of a given set of applications as they relate to the location of the user. The distributed CCF control sub-elements may be associated with applications that are local to, or near, one of the networks 630, edge devices 640, or clients elements 650, while interfacing with a supra-element farther up the hierarchy of the network. Each network entity may have a localized application distribution through the Network Applications (Net Apps[2]) 740, Edge Applications (Edge Apps [2]) 750, and Client Applications (Client Apps[2]) 760. Each of these applications may be associated with a particular application and access network even though the applications themselves are physically distributed across the network.

The context manager (CM) 310 is a system in a CSF network that collects, processes, and provides context state information for use in applications serving end users. The CM 310 receives inputs from control element enablers, such as a preference manager 242, session monitor 244, and resource manager 246. The session monitor 244 also contains a mechanism for determining a user's location via location and presence servers in the network. The CM 310 processes these inputs against the converged service request to determine if the solution to the converged service request has been achieved at the current control element level in the hierarchy or if the request should be passed up the control hierarchy for further processing. Therefore the CM 310 may determine whether the service manager element 250 in the CSF algorithm will be able to decide who to publish the converged service request to, e.g. to the resource owners (AN, clients, RGW etc), or whether the service management element 250 will need to request a supra-element with a higher level of a hierarchical control to process the request. The supra-element may process the request or delegate processing of that request to an intermediate sub-element with greater hierarchical control than the sub-element but less than the supra-element.

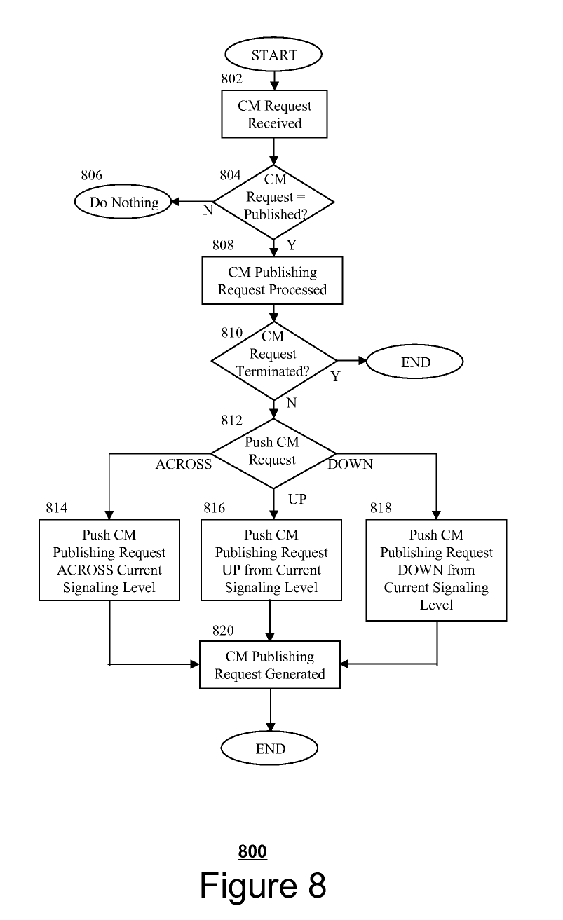

FIG. 8 illustrates one embodiment of a method 800 for publishing a context manager request. The CM 310 receives a request for service (Block 802). If the CM request is not a publication request (Block 804), no further publishing action is required (Block 806). If the CM request is a publication request (Block 804), the CM publishing request may be processed (Block 808). If the CM request is terminated (Block 810), the CM does nothing with the request (Block 806). If the CM request needs to be pushed to a different control element (Block 812), the CM request may be pushed across the current signaling level (Block 814), up the current signaling level (Block 816), or down the current signaling level (Block 818). The control element may then generate a CM publishing request (Block 820).

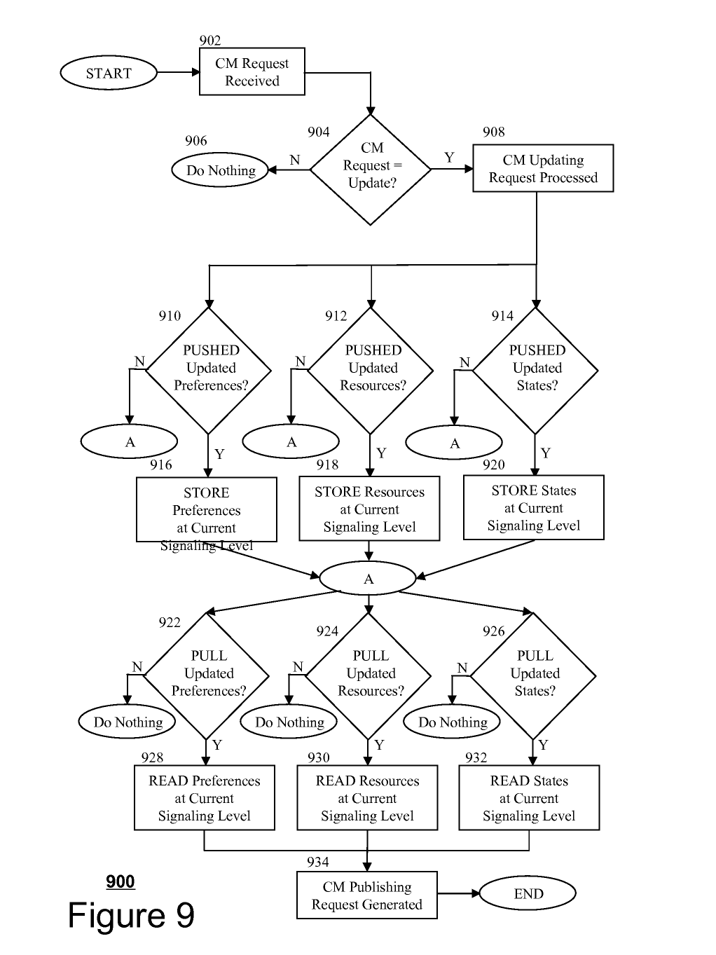

FIG. 9 illustrates one embodiment of a method 900 for updating the CM 310. CM 310 receives a CM request (Block 902). If the CM request is not an update (Block 904), no further action is required (Block 906). Otherwise, the CM updating request is processed (Block 908). If the CM request is pushing updated preference (Block 910), resource (Block 912), or state data (Block 914), the preference (Block 916), resource (Block 918), or state data (Block 920) is stored with the CM 310. If the CM request is pulling updated preference (Block 922), resource (Block 924), or state data (Block 926), the preference (Block 928), resource (Block 930), or state data (Block 932) is read from the CM 310. The CM then generates a CM publishing request (Block 934).

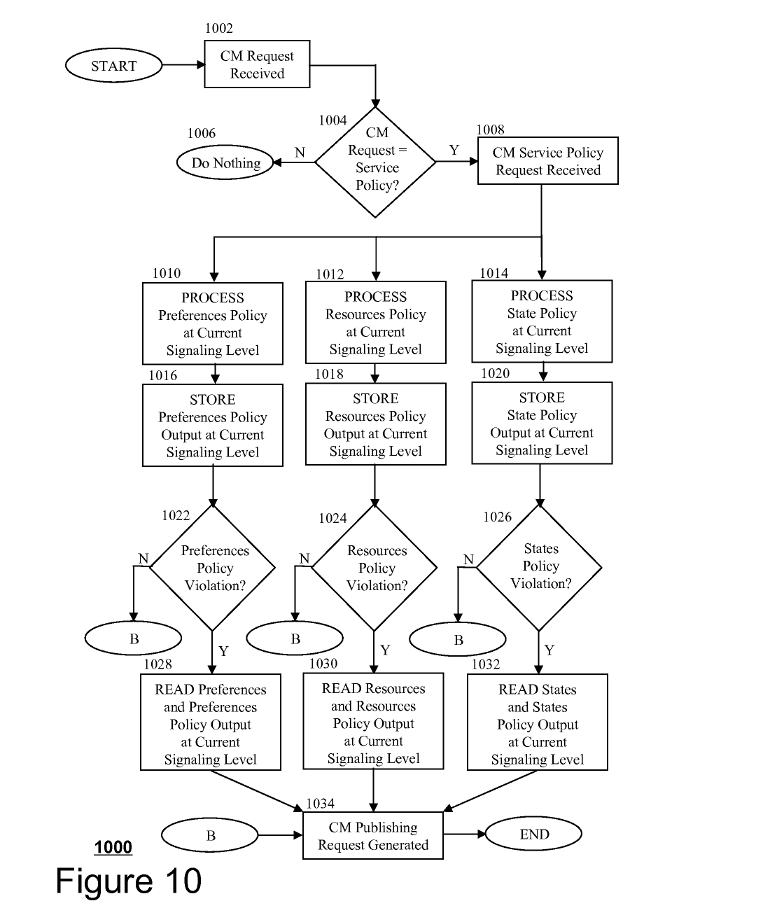

FIG. 10 illustrates one embodiment of a method 1000 for updating the CM 310. CM 310 receives a CM request (Block 1002). If the CM request is request for service (Block 1004), no further action is required (Block 1006). Otherwise, the CM service policy request is processed (Block 1008). If the CM request requests processing of preference (Block 1010), resource (Block 1012), or state policy (Block 1014), the preference (Block 1016), resource (Block 1018), or state data (Block 1020) is stored with the CM 310. If a preference (Block 1022), resource (Block 1024), or state policy violation (Block 1026) occurs, the CM 310 reads preferences and preferences policy output (Block 1028), resources and resources policy output (Block 1030), or states and states policy (Block 1032). The CM then generates a CM publishing request (Block 1034).

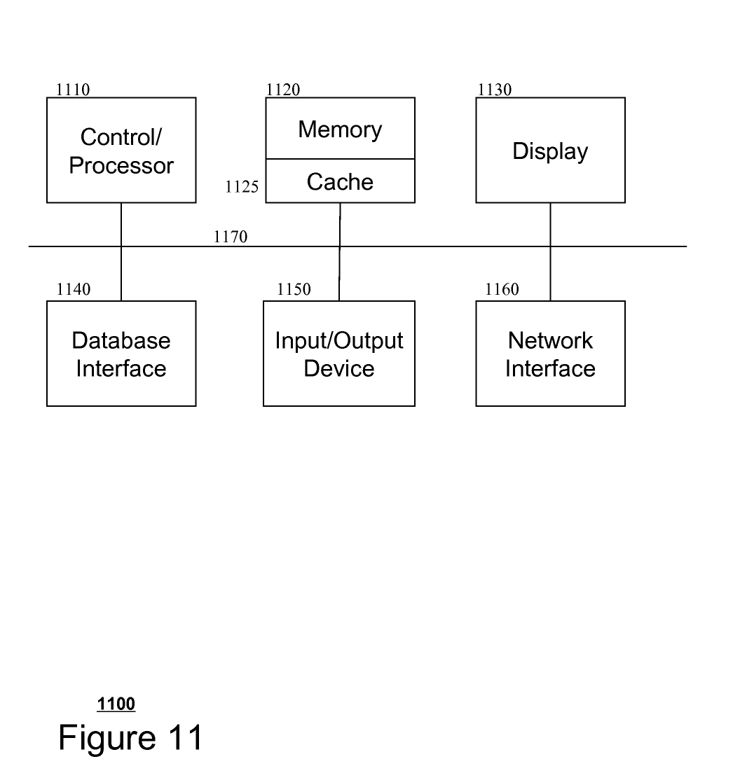

FIG. 11 illustrates a possible configuration of a computer system 1100 to act as a user terminal or server to execute the present invention. The computer system 1100 may include a controller/processor 1110, a memory 1120 with a cache 1125, display 1130, database interface 1140, input/output device interface 1150, and network interface 1160, connected through bus 1170.

The controller/processor 1110 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 1120 may include volatile and nonvolatile data storage, including one or more electrical, magnetic or optical memories such as a RAM, cache, hard drive, CD-ROM drive, tape drive or removable storage disk. The memory may have a cache 1125 to speed access to specific data.

The Input/Output interface 1150 may be connected to one or more input devices that may include a keyboard, mouse, pen-operated touch screen or monitor, voice-recognition device, or any other device that accepts input. The Input/Output interface 1150 may also be connected to one or more output devices, such as a monitor, printer, disk drive, speakers, or any other device provided to output data.

The network interface 1160 may be connected to a communication device, modem, network interface card, a transceiver, or any other device capable of transmitting and receiving signals over a network. The components of the computer system 1100 may be connected via an electrical bus 1170, for example, or linked wirelessly.

Client software and databases may be accessed by the controller/processor 1110 from memory 1120 or through the database interface 1140, and may include, for example, database applications, word processing applications, the client side of a client/server application such as a billing system, as well as components that embody the decision support functionality of the present invention. The computer system 1100 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for providing a converged service across domains, comprising:
providing a converged service instance across a plurality of independent networks to an end user;
selecting a hierarchical control sub-element using a context manager; and
controlling with the hierarchical control sub-element an aspect of the converged service instance.

2. The method of claim 1, further comprising:
locating the hierarchical control sub-element near the end user;
locating a hierarchical control supra-element near an application server implementing a service of the converged service;
interfacing the hierarchical control sub-element with the hierarchical control supra-element.

3. The method of claim 2, wherein the hierarchical control sub-element has a narrower scope of control than the hierarchical control supra-element.

4. The method of claim 2, further comprising:
locating an intermediate control sub-element between the hierarchical control supra-element and the hierarchical control sub-element; and
delegating control of the hierarchical control sub-element to the intermediate control sub-element.

5. The method of claim 2, further comprising:
associating a first instance of the context manager with the hierarchical control sub-element; and
associating a second instance of the context manager with the hierarchical control supra-element.

6. The method of claim 5, further comprising:
updating context state information stored by the first instance; and
synchronizing the context state information stored by the second instance.

7. The method of claim 1, further comprising:
collecting context state information using the context manager;
determining a location of an end user and locations of application servers;
associating the location with user specific context state information and application specific context state information; and
selecting the hierarchical control sub-element to manage the converged service instance.

8. The method of claim 1, further comprising locating the context manager and hierarchical control sub-element in a network, edge device or a client device.

9. An apparatus that provides a converged service across domains, comprising:
an interface device that provides a converged service instance from a plurality of independent networks to an end user;
a hierarchical control sub-element that controls an aspect of the converged service instance.
a first context manager that selects the hierarchical control sub-element.

10. The apparatus of claim 9, wherein the hierarchical control sub-element interfaces with a hierarchical control supra-element located near an application server implementing a service of the converged service.

11. The apparatus of claim 10, wherein the hierarchical control sub-element has a narrower scope of control than the hierarchical control supra-element.

12. The apparatus of claim 10, wherein the first context manager updates stored context state information stored and synchronizes the stored context state information with a second context manager associated with the hierarchical control supra-element.

13. The apparatus of claim 9, wherein the context manager collects context state information, determines a location of an end user and locations of application servers, associates the location with user specific context state information and application specific context state information, and selects the hierarchical control sub-element to manage the converged service instance.

14. The apparatus of claim 9, wherein the interface device is a network, edge device or a client device.

15. An electronic device that provides a converged service across domains, comprising:
an interface device that provides a converged service instance from a plurality of independent networks to an end user;
a hierarchical control sub-element that controls an aspect of the converged service instance.
a first context manager that selects the hierarchical control sub-element.

16. The electronic device of claim 15, wherein the hierarchical control sub-element interfaces with a hierarchical control supra-element located near an application server implementing a service of the converged service.

17. The electronic device of claim 16, wherein the hierarchical control sub-element has a narrower scope of control than the hierarchical control supra-element.

18. The electronic device of claim 16, wherein the first context manager updates stored context state information stored and synchronizes the stored context state information with a second context manager associated with the hierarchical control supra-element.

19. The electronic device of claim 15, wherein the context manager collects context state information, determines a location of an end user and locations of application servers, associates the location with user specific context state information and application specific context state information, and selects the hierarchical control sub-element to manage the converged service instance.

20. The electronic device of claim 15, wherein the interface device is a network, edge device or a client device.
